(19) United States
(12) Patent Application Publication
(10) Pub. No.: US 2004/0028193 A1
(43) Pub. Date: Feb. 12, 2004

(54) Multi-channel digital recording system and method using network

(75) Inventor: Eric Kim, Seoul (KR)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: USD CO., LTD.

(21) Appl. No.: 10/299,901

(22) Filed: Nov. 20, 2002

(30) Foreign Application Priority Data
Aug. 8, 2002 (KR) 2002-46847

(51) Int. Cl. H04M 1/64

(52) U.S. Cl. 379/68; 379/67.1

(57) ABSTRACT

A multi-channel digital recording system and method using a network, which can record and monitor telephone conversation contents on a real time basis over a multiplicity of traffic channels using network environments. The method comprises the step of allowing a PABX to connect a call between an arbitrary customer telephone and an arbitrary adviser telephone if the arbitrary customer telephone is connected to the PABX over a PSTN or VOIP-based telephone network, the step of allowing the arbitrary adviser telephone to transfer contents of a telephone conversation with an arbitrary customer corresponding to the arbitrary customer telephone to an arbitrary adviser PC corresponding to the arbitrary adviser telephone in the form of an analog voice signal, the step of allowing the arbitrary adviser PC to convert the analog voice signal transferred from the arbitrary adviser telephone into a digital voice signal, convert the converted digital voice signal into computer-readable audio data through a predetermined compression process and transfer the converted audio data to a telephone conversation contents recording server on a real time basis, and the step of allowing the conversation contents recording server to record the audio data transferred from the arbitrary adviser PC.

### BACKGROUND OF THE INVENTION

1. Field of the Invention

The present invention relates to a multi-channel digital recording system and method, and more particularly to a multi-channel digital recording system and method using a network, which can record and monitor telephone conversation contents on a real time basis over a multiplicity of traffic channels using network environments.

2. Description of the Related Art

As well known to those skilled in the art, multi-channel digital recording systems are mostly used in mail-order centers or customer service centers to record telephone conversation contents between a number of customers and each adviser along with talk times (years, months, days, hours, minutes and seconds) so that the recorded telephone conversation contents can be utilized as corroborative data when a problem associated with the conversation contents occurs at a later time.

Such a conventional multi-channel digital recording system is connected over a separate recording line to an MDF (Main Distribution Frame), which is in turn connected to a PABX (Private Automatic Branch exchange). Here, the PABX is also connected to a PSTN (Public Switched Telephone Network).

Because the conventional multi-channel digital recording system is connected to the MDF over the separate line as mentioned above, it requires the same number of recording equipment channels as advice telephone lines. The multi-channel digital recording system further needs the same number of separate playback channels for monitoring as managers, each managing a plurality of advisers, and line constructions from each adviser's seat to the equipment (MDF and PABX).

For these reasons, the conventional multi-channel digital recording system has a disadvantage in that line installations and system settings must be again conducted when the advisers' seats are changed in their positions. Further, a separate space where the equipment is to be installed is required, causing considerable restrictions in place where the system is to be re-installed. Furthermore, it is not easy to discriminate line states based on line connection or disconnection, and separate playback lines are further required.

Besides, the recording lines from the respective telephones to the recording equipment and the respective playback channels for monitoring are essentially required, resulting in installation costs of the entire system being excessive and complex works being required for line arrangement and connection. Moreover, because only voice data between advisers and customers is successively recorded, a considerable amount of time is required in searching for a voice conversation record on a specific date or for a specific customer at a later time.

### SUMMARY OF THE INVENTION

Therefore, the present invention has been made in view of the above problems, and it is an object of the present invention to provide a multi-channel digital recording system which is capable of making the entire installation simpler using computer and network environments, and a multi-channel digital recording method which is capable of selectively recording and monitoring telephone conversation contents on a real time basis over a multiplicity of traffic channels and facilitating searches for conversation records, using the multi-channel digital recording system.

In accordance with one aspect of the present invention, the above and other objects can be accomplished by the provision of a method for recording telephone conversation contents between a plurality of advisers and a plurality of customers in a multi-channel digital recording system using a network, the system including a plurality of adviser telephones, a plurality of adviser personal computers (PCs) connected respectively with the adviser telephones, a telephone conversation contents recording server connected with the adviser PCs over the network, and a PABX (Private Automatic Branch eXchange) for relaying calls between the adviser telephones and a telephone network, the method comprising the steps of: a) allowing the PABX to connect a call between an arbitrary customer telephone and an arbitrary one of the adviser telephones if the arbitrary customer telephone is connected to the PABX over the telephone network; b) allowing the arbitrary adviser telephone to transfer contents of a telephone conversation with an arbitrary one of the customers corresponding to the arbitrary customer telephone to an arbitrary one of the adviser PCs corresponding to the arbitrary adviser telephone in the form of an analog voice signal; c) allowing the arbitrary adviser PC to convert the analog voice signal transferred from the arbitrary adviser telephone into a digital voice signal, convert the converted digital voice signal into computer-readable audio data through a predetermined compression process and transfer the converted audio data to the telephone conversation contents recording server on a real time basis; and d) allowing the conversation contents recording server to record the audio data transferred from the arbitrary adviser PC.

In accordance with another aspect of the present invention, there is provided a method for recording telephone conversation contents between a plurality of advisers and a plurality of customers in a multi-channel digital recording system using a network, the system including a plurality of adviser telephones, a plurality of adviser personal computers (PCs) connected respectively with the adviser telephones, a telephone conversation contents recording server connected with the adviser PCs over the network, and a PABX (Private Automatic Branch eXchange) for relaying calls between the adviser telephones and a telephone network, the method comprising the steps of: a) prestoring a plurality of selection menus in the PABX in the form of voice guidance messages and setting in each of the adviser PCs a recording condition for selective execution of telephone conversation contents recording according to advice menus; b) allowing the PABX to send a guidance message to an arbitrary customer telephone to request an arbitrary one of the customers corresponding to the arbitrary customer telephone to select one of the advice menus, if the arbitrary customer telephone is connected to the PABX over the telephone network; c) allowing the PABX to, if one of the advice menus is selected by the arbitrary customer and a DTMF signal corresponding thereto is inputted from the customer telephone, connect a call between the customer telephone and an arbitrary one of the adviser telephones, identify the inputted DTMF signal and notify an arbitrary one of the adviser PCs corresponding to the arbitrary adviser telephone of the selected advice menu; d) allowing the arbitrary adviser telephone to transfer contents of a telephone conversation with the arbitrary customer to the arbitrary adviser PC in the form of an analog voice signal; e) allowing the arbitrary adviser PC to, if the notified advice menu corresponds to the set recording condition, convert the analog voice signal transferred from the arbitrary adviser telephone into a digital voice signal, convert the converted digital voice signal into computer-readable audio data through a predetermined compression process and transfer the converted audio data to the telephone conversation contents recording server on a real time basis; and f) allowing the conversation contents recording server to record the audio data transferred from the arbitrary adviser PC.

In accordance with yet another aspect of the present invention, there is provided a multi-channel digital recording system for recording telephone conversation contents over a plurality of traffic channels using network environments, comprising: a PABX for controlling call connections for a plurality of customer telephones connected thereto over a telephone network; a plurality of adviser telephones connected with the customer telephones via the PABX, the adviser telephones outputting contents of telephone conversations with the customer telephones in the form of analog voice signals; a plurality of interface modules connected respectively with the adviser telephones, the interface modules interfacing the analog voice signals from the adviser telephones, respectively; a plurality of adviser PCs connected respectively with the interface modules, the adviser PCs converting the analog voice signals provided from the interface modules into digital voice signals and compressing the converted digital voice signals into computer-readable audio data, respectively; and a telephone conversation contents recording server connected with the adviser PCs via a local area network (LAN), the recording server recording the audio data from the adviser PCs.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing the entire construction of a multi-channel digital recording system in accordance with the present invention;

FIG. 2 is a flow chart illustrating a call connection control process in a telephone conversation recording process of the multi-channel digital recording system in accordance with the present invention;

FIG. 3 is a flow chart illustrating a process of selectively recording telephone conversation contents in accordance with a preferred embodiment of the present invention;

FIG. 4 is a flow chart illustrating a process of selectively recording telephone conversation contents in accordance with an alternative embodiment of the present invention; and

FIG. 5 is a flow chart illustrating a telephone conversation monitoring process in the telephone conversation recording process of the multi-channel digital recording system in accordance with the present invention.

### DESCRIPTION OF THE PREFERRED EMBODIMENTS

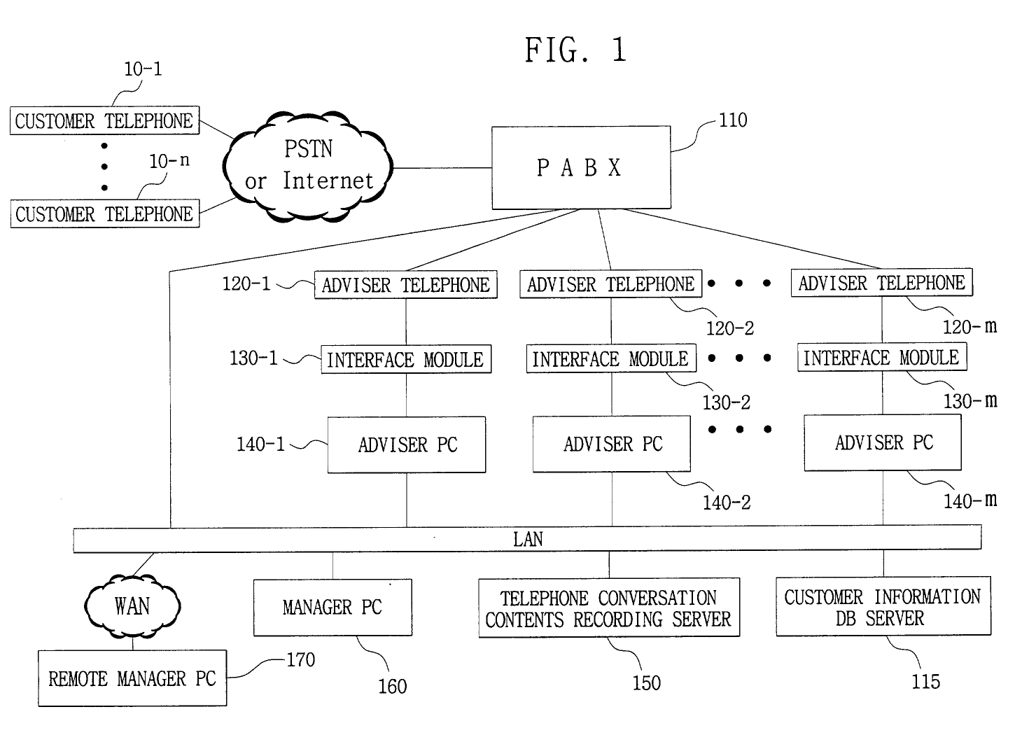

With reference to FIG. 1, there is shown in block form the entire construction of a multi-channel digital recording system in accordance with the present invention. As shown in this drawing, the multi-channel digital recording system comprises a PABX (Private Automatic Branch exchange) 110, a customer information database (DB) server 115, a plurality of adviser telephones 120-1, 120-2, . . . , 120-m, a plurality of interface modules 130-1, 130-2, . . . , 130-m, a plurality of adviser personal computers (PCs) 140-1, 140-2, . . . , 140-m, a telephone conversation contents recording server 150, a manager PC 160, and a remote manager PC 170.

The adviser telephones 120-1, 120-2, . . . , 120-m are each connected to the PABX 110, and the adviser PCs 140-1, 140-2, . . . , 140-m, the conversation contents recording server 150 and the manager PC 160 are interconnected via a local area network (LAN). The remote manager PC 170 is connected to the LAN over a wide area network (WAN) such as the Internet.

A description will hereinafter be given of the respective constituent means of the multi-channel digital recording system with reference to FIG. 1. First, the PABX 110 acts to connect and relay calls between customer telephones 10-1, 10-2, . . . , 10-n, connected thereto over the PSTN or Internet, and the adviser telephones 120-1, 120-2, . . . , 120-m. That is, the PABX 110 has a function of processing a VOIP (Voice Over Internet Protocol)-based call connection over the Internet, as well as a general exchange function of performing a call connection over the PSTN. Recently, electronic exchanges have been developed and popularized which include gateways to enable VOIP-based call connections. In this regard, in the present invention, such an electronic exchange is employed in the PABX 110 to enable both a call connection over the PSTN and a VOIP-based call connection over the Internet.

The PABX 110 also functions to, at an initial step where an arbitrary customer telephone is connected thereto, send out a guidance message using an audio response system (ARS) function to guide a customer to enter basic customer information (for example, a resident registration number or other unique numbers) and select a type of advice contents, etc. The PABX 110 further functions to control the connection of the customer telephone with an arbitrary adviser telephone by recognizing a dual tone multi-frequency (DTMF) signal which is inputted from the customer telephone on the basis of the guidance message. To this end, the PABX 110 has a computer telephony integration (CTI) function for provision of an ARS service, which can be readily implemented by mounting a typical CTI board, already widely used, to the PABX 110.

The customer information DB server 115 shown in FIG. 1 is adapted to store detailed information regarding a plurality of customers, which may be different according to companies operating the multi-channel digital recording system of the present invention. For example, in case of a credit card company, the detailed information may include information about a credit rating, a card number, an address, a customer grade, the amount of money to be settled, etc. of each customer. The customer information DB server 115 reads out detailed information regarding a specific customer on the basis of basic customer information (a resident registration number or other unique numbers) recognized and provided by the PABX 110, and then provides the read-out detailed information to an adviser computer to be described later, so that an adviser can read the detailed information regarding the customer through a screen before advising the customer.

The interface modules 130-1, 130-2, . . . , 130-m, are connection means for connecting the adviser telephones 120-1, 120-2, . . . , 120-m with the adviser PCs 140-1, 140-2, . . . , 140-m, respectively, and act to transfer output voice signals from the adviser telephones 120-1, 120-2, . . . , 120-m to the adviser PCs 140-1, 140-2, . . . , 140-m, respectively. Here, the voice signals transferred through the interface modules 130-1, 130-2, . . . , 130-m signify the contents of telephone conversations between customers and advisers.

The adviser PCs 140-1, 140-2, . . . , 140-m are general personal computers, and are connected with the corresponding adviser telephones 120-1, 120-2, . . . , 120-m via the interface modules 130-1, 130-2, . . . , 130-m, respectively. The adviser PCs 140-1, 140-2, . . . , 140-m act to convert the voice signals provided through the corresponding interface modules 130-1, 130-2, . . . , 130-m into digital signals, perform predetermined compression and coding operations with respect to the converted digital signals and then transfer the resulting signals to the telephone conversation contents recording server 150 to be described later, respectively. To this end, the adviser PCs 140-1, 140-2, . . . , 140-m each include a digital signal processor (DSP) for performing a digital signal process, which can be readily implemented using a sound card used in a typical computer. Namely, a digital signal-processable sound card is contained in each of the adviser PCs 140-1, 140-2, . . . , 140-m, and connected to each of the interface modules 130-1, 130-2, . . . , 130-m to receive an analog voice signal based on telephone conversation contents therefrom. Here, the entire construction of each of the adviser PCs 140-1, 140-2, . . . , 140-m, including the sound card, input/output control means for control of the sound card, a central processing unit (CPU), memory means, etc., is the same as that of a general personal computer, and details thereof are omitted in FIG. 1.

The adviser PCs 140-1, 140-2, . . . , 140-m each also include predetermined compression and coding algorithms in the form of programs to compress and code a voice signal digitally converted through the sound card. Here, the compression algorithm for compressing the voice signal may be, for example, Microsoft CCITT G.711 A-Lau and u-Law CODEC, Microsoft G.723.1 CODEC, Windows Media Audio, Fraunhofer IIS MPEG Layer-3 CODEC, Microsoft IMA ADPCM CODEC or etc. This compression algorithm is well known in the art and a detailed description thereof will thus be omitted.

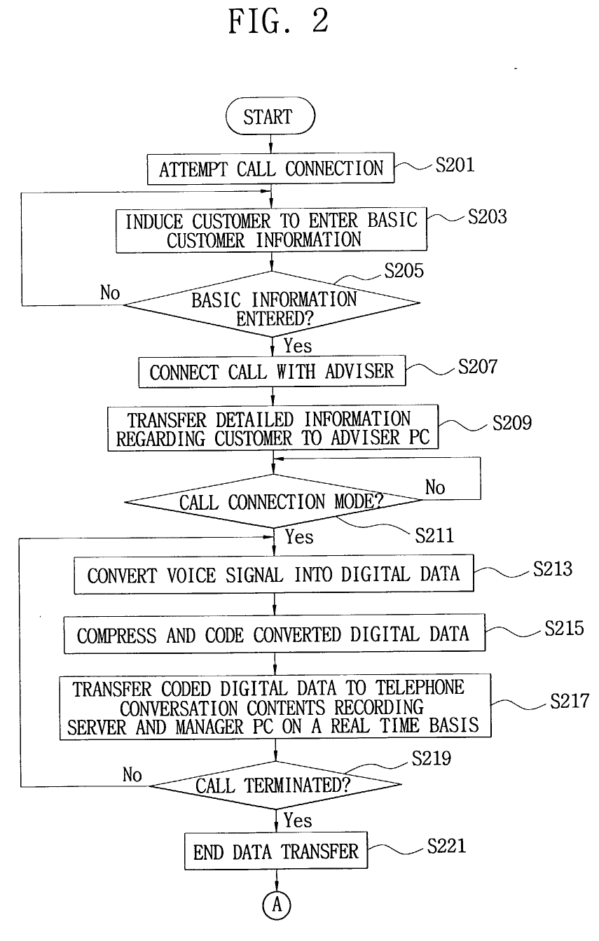

In particular, according to the present invention, in the process of transferring the compressed and coded voice signal, the adviser PCs 140-1, 140-2, . . . , 140-m each receive information regarding a talking customer as well as information regarding a corresponding adviser from the customer information DB server 115 and transfer the received information together with the voice signal, which will be described later in detail with reference to FIG. 2.

The telephone conversation contents recording server 150 is connected with the adviser PCs 140-1, 140-2, . . . , 140-m via the LAN to record data compressed/coded and transferred by the adviser PCs 140-1, 140-2, . . . , 140-m in an internal database thereof, not shown. That is, the conversation contents recording server 150 records digital voice data provided from the adviser PCs 140-1, 140-2, . . . , 140-m and additional data (adviser information and customer information) transferred therewith in a database form, thereby making it easy to search for telephone conversation contents (digital voice data) of each customer using the additional data at a later time. In particular, the conversation contents recording server 150 records all data provided from the adviser PCs 140-1, 140-2, . . . , 140-m, or selectively records the provided data according to a preset recording schedule. The applied recording schedule is made out in the manager PC 160 and then transferred to the conversation contents recording server 150 via the LAN.

In the manager PC 160, the recording schedule for control of the recording operation of the telephone conversation contents recording server 150, as stated above, is made out by a manager. In the recording schedule, recording start times and end times by recording channels are sequentially recorded. Here, the recording channels signify individual data transfer paths between the respective adviser PCs 140-1, 140-2, . . . , 140-m and the conversation contents recording server 150.

Besides the above-described function of making out the recording schedule, the manager PC 160 has a real-time monitoring function for each channel. In detail, a manager operating the manager PC 160 accesses the respective adviser PCs 140-1, 140-2, . . . , 140-m, checks whether the respective adviser PCs 140-1, 140-2, . . . , 140-m are in a recording mode, selects an arbitrary adviser PC being in the recording mode from among them, and receives a digital voice signal outputted from the selected adviser PC. Because the received digital voice signal is a signal compressed and coded through the predetermined signal processing operations, the manager PC 160 decodes and decompresses the digital voice signal into a signal prior to the coding and then outputs the resulting telephone conversation contents between a corresponding adviser and a talking customer, so that the manager can monitor the telephone conversation contents. Here, the manager PC 160 prestores decoding and decompression algorithms for decoding and decompressing the digital voice signal, in the form of computer programs.

On the other hand, the remote manager PC 170 connected via the WAN performs the same role as that of the above-described manager PC 160, with the exception that it is connected to the multi-channel digital recording system according to the present invention via the WAN such as the Internet, not the LAN. Also, the remote manager PC 170 has the same function as that of the manager PC 160.

Next, a detailed description will be given of a telephone conversation recording process performed by the multi-channel digital recording system with the above-stated construction with reference to respective flow charts.

FIG. 2 is a flow chart illustrating a call connection control process in the telephone conversation recording process in accordance with the present invention, in which the PABX 110 controls call connections between the customer telephones 10-1, 10-2, . . . , 10-n and the adviser telephones 120-1, 120-2, . . . , 120-m.

A description will be given using the customer telephone 10-1 and adviser PC 140-1 as examples, among the customer telephones 10-1, 10-2, . . . , 10-n and adviser PCs 140-1, 140-2, . . . , 140-m shown in FIG. 1.

First, a customer desiring telephone advice attempts a call connection with an adviser by dialing over the telephone 10-1 (step S201). At this time, the PABX 110 connects a call with the customer telephone 10-1 and then requests the customer to enter basic customer information (a resident registration number, unique subscriber number or the like) using the ARS function (step S203). As a result, the customer requests advice with the adviser by entering the basic information requested by the PABX 110 over the telephone 10-1 (step S205).

The PABX 110 recognizes the basic customer information (the resident registration number, etc.) by discriminating a DTMF signal inputted from the customer telephone 10-1, and then connects the customer telephone 10-1 with the call-connectable adviser telephone 120-1 (step S207).

If a call is connected between the customer telephone 10-1 and the adviser telephone 120-1 at the above step S207, then the PABX 110 sends the basic customer information to the customer information DB server 115 such that the server 115 transfers detailed information regarding the corresponding customer to the adviser PC 140-1. As a result, the detailed information regarding the call-connected customer is displayed in the adviser PC 140-1 connected with the customer telephone 10-1, so the adviser can read the detailed information before advising the customer (step S209).

If the customer telephone 10-1 is connected with the adviser telephone 120-1 and the detailed information of the customer is transferred to the adviser PC 140-1, through the above respective steps, then the adviser PC 140-1 transfers the contents of a telephone conversation between the customer and the adviser to the telephone conversation contents recording server 150 through predetermined signal processing operations. That is, first, the adviser PC 140-1 automatically determines whether the adviser is in a call connection mode by checking the presence or not of an external input voice signal. Here, the call connection mode determination function can be readily implemented by a specific frequency detection function, etc., or may be implemented using an application program so that the adviser can personally select the call connection mode as needed. This call connection mode determination function is well known in the art and a detailed description thereof will thus be omitted.

If the adviser PC 140-1 recognizes the call connection mode by detecting an external input voice signal, or the adviser selects the call connection mode (step S211), then the adviser PC 140-1 changes its entire operation mode to a telephone conversation contents recording mode according to a computer program prestored therein. As a result, the adviser PC 140-1 converts an analog voice signal inputted from the interface module 130-1 into digital data (step S213), and compresses and codes the converted digital data according to predetermined algorithms (step S215). The adviser PC 140-1 then transfers the coded digital data to the telephone conversation contents recording server 150 and manager PC 160 (step S217).

While the voice signal from the interface module 130-1 is transferred, namely, the adviser is in the call connection mode, the above respective steps S211 to S215 are continuously performed such that the telephone conversation contents between the customer and the adviser are converted into digital data and transferred on a real time basis to the telephone conversation contents recording server 150 and manager PC 160 through the predetermined compression and coding processes.

Thereafter, if no input voice signal from the interface module 130-1 is present due to a call termination by the adviser (step S219), the adviser PC 140-1 ends the real-time data transfer operation as stated above (step S221).

The above respective steps are automatically performed by all the adviser PCs 140-1, 140-2, . . . , 140-m whenever voice signals from the respective interface modules 130-1, 130-2, . . . , 130-m are inputted.

On the other hand, the telephone conversation contents recording server 150 receives and stores on a real time basis digital data (telephone conversation contents) which are provided from the respective adviser PCs 140-1, 140-2, . . . , 140-m through the respective steps shown in FIG. 2. That is, the conversation contents recording server 150 records all telephone conversation contents between advisers and customers by sequentially storing all digital data generated from the respective adviser PCs 140-1, 140-2, . . . , 140-m. At this time, the conversation contents recording server 150 records talking dates and times and adviser information and customer information corresponding respectively to the channels, along with the telephone conversation contents, so that the conversation contents can be easily searched for at a later time.

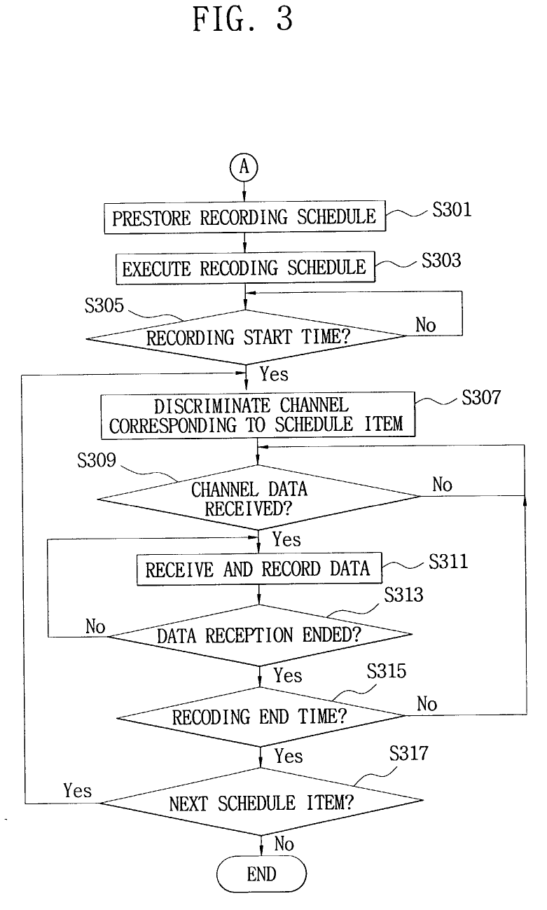

Alternatively, the conversation contents recording server 150 may selectively store digital data (telephone conversation contents) provided from the respective adviser PCs 140-1, 140-2, . . . , 140-m, as shown in FIG. 3. FIG. 3 is a flow chart illustrating a process of selectively recording telephone conversation contents by the conversation contents recording server 150. That is, the conversation contents recording server 150 selectively records digital data (telephone conversation contents) provided from the respective adviser PCs 1401, 140-2, . . . , 140-m according to a predetermined recording schedule.

To this end, the conversation contents recording server 150 receives and prestores a recording schedule made out by the manager PC 160 (step S301) and then executes the prestored recoding schedule (step S303).

Then, the conversation contents recording server 150 reads the recording schedule, and compares a recording start time recorded therein with the current time to continuously check whether there is a schedule item to be performed (step S305). If the current time has reached a recording start time for an arbitrary channel included in the recording schedule (step S305), the conversation contents recording server 150 discriminates a channel corresponding to the current schedule item (step S307) and then determines whether data from the discriminated channel is sent (step S309). Namely, the conversation contents recording server 150 determines whether an adviser corresponding to the channel is in the call connection mode by determining whether data from an adviser PC corresponding to the current schedule item is sent.

In the case where it is determined from the provision of no data from the corresponding channel that the adviser is not in the call connection mode, the conversation contents recording server 150 continuously checks whether the adviser is in the call connection mode until a recording end time for the corresponding channel set in the recording schedule.

If data from the corresponding channel is received, then the conversation contents recording server 150 records the received data in its internal database (step S311). At this time, the conversation contents recording server 150 records a talking date and time and adviser information and customer information corresponding to the channel, along with the received data, so that the conversation contents can be easily searched for at a later time.

If the data reception is ended due to a call termination by the adviser while the conversation contents of the channel corresponding to the current recording schedule item are recorded through the above steps (step S313), then the conversation contents recording server 150 checks a recoding end time for the current channel to record the telephone conversation contents of the adviser by repeating the above steps beginning with step S309 until the current time reaches the recording end time (step S315).

If the current time reaches the recording end time for the current channel, then the conversation contents recording server 150 reads the recording schedule again to determine whether there is a next schedule item to be performed (step S317). In the case where there is a next schedule item to be performed, the conversation contents recording server 150 repeats the above steps beginning with step S307. In this manner, the conversation contents recording server 150 performs and completes the recording process with respect to all channels included in the recording schedule.

On the other hand, it is preferred that the respective adviser PCs 140-1, 140-2, . . . , 140-m are not allowed to recognize the recording schedule performed by the conversation contents recording server 150 while the telephone conversation contents recording process as described above is performed. That is, according to the present invention, although the conversation contents recording server 150 does not record telephone conversation contents with respect to all channels, the respective adviser PCs 140-1, 140-2, . . . , 140-m are not allowed to recognize whether the recoding operation is actually performed. Accordingly, all advisers conducting telephone advice in a customer service center or mail-order center will be induced to work faithfully.

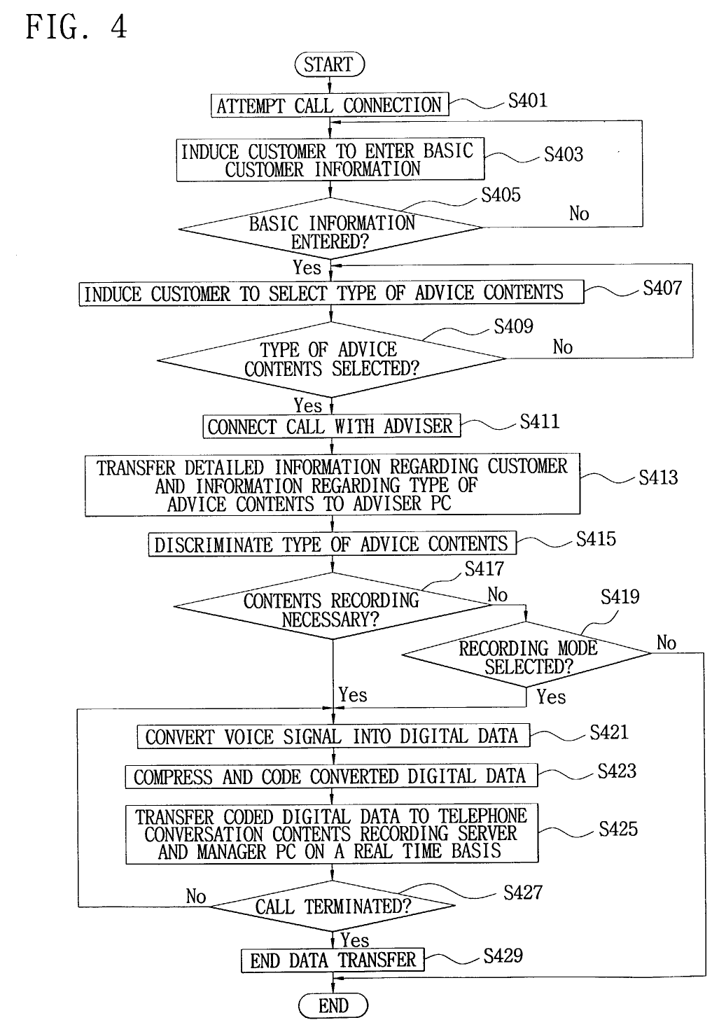

FIG. 4 is a flow chart illustrating a process of selectively recording telephone conversation contents in accordance with an alternative embodiment of the present invention. Although the recording process has been disclosed in the first embodiment shown in FIG. 3 to selectively record the telephone conversation contents of the respective advisers according to the recording schedule made out in the manager PC 160 or 170, the recording process is performed in the second embodiment to selectively record the telephone conversation contents according to advice contents of customers, in a different manner from that of the first embodiment.

A detailed description will hereinafter be given of the recording process according to the second embodiment with reference to FIG. 4. As in the above-stated first embodiment, a customer desiring telephone advice attempts a call connection with an adviser by dialing over the telephone 10-1 (step S401). At this time, the PABX 110 connects a call with the customer telephone 10-1 and then requests the customer to enter basic customer information (a resident registration number, unique number or the like) using the ARS function (step S403).

If the customer enters the basic information requested by the PABX 110 over the telephone 10-1 (step S405), then the PABX 110 recognizes the basic customer information (the resident registration number, etc.) by discriminating a DTMF signal inputted from the customer telephone 10-1, and then sends out a guidance message to guide the customer to select a type of advice contents (step S407). At this time, types of advice contents selectable through the guidance message may be defined in different manners according to companies operating the multi-channel digital recording system of the present invention.

On the other hand, if the customer selects a desired type of advice contents (step S409), then the PABX 110 identifies the type of advice contents desired by the customer by discriminating a DTMF signal inputted from the customer telephone 10-1, and then connects the customer telephone 10-1 with the call-connectable adviser telephone 120-1 (step S411).

If a call is connected between the customer telephone 10-1 and the adviser telephone 120-1, then the PABX 110 sends the basic customer information to the customer information DB server 115 such that the server 115 transfers detailed information regarding the corresponding customer to the adviser PC 140-1. The PABX 110 further sends information regarding the type of advice contents selected by the customer to the adviser PC 140-1 (step S413). As a result, the detailed information regarding the call-connected customer is displayed in the adviser PC 140-1 connected with the customer telephone 10-1, and the information regarding the type of advice contents selected by the customer is received by the adviser PC 140-1.

At this time, the adviser PC 140-1 discriminates the type of advice contents selected by the customer (step S415) to determine whether the recording of telephone conversation contents is necessary (step S417), so as to selectively perform the below steps beginning with step S421. The yardstick for determination may be different according to companies employing the multi-channel digital recording system of the present invention and be set by the adviser or manager at his/her discretion. Even in the case where it is determined at the above step S417 that the recording of telephone conversation contents is not necessary, the below steps beginning with step S421 are performed if the adviser manually selects a telephone conversation contents recording mode by operating the adviser PC 140-1 (step S419).

Accordingly, in the case where it is determined at the above step S417 that the recording of telephone conversation contents is necessary, or in the case where the adviser selects the conversation contents recording mode at the above step S419, the adviser PC 140-1 changes its entire operation mode to the conversation contents recording mode according to a computer program prestored therein. As a result, the adviser PC 140-1 converts an analog voice signal inputted from the interface module 130-1 into digital data (step S421), and compresses and codes the converted digital data according to predetermined algorithms (step S423). The adviser PC 140-1 then transfers the coded digital data to the telephone conversation contents recording server 150 and manager PC 160 (step S425).

While the voice signal from the interface module 130-1 is transferred, namely, the adviser is in a call connection mode, the conversation contents recording mode is continuously performed such that the telephone conversation contents between the customer and the adviser are converted into digital data and transferred on a real time basis to the telephone conversation contents recording server 150 and manager PC 160 through the predetermined compression and coding processes.

Thereafter, in the case where no input voice signal from the interface module 130-1 is present due to a call termination by the adviser (step S427), the adviser PC 140-1 ends the real-time data transfer operation as stated above (step S429).

On the other hand, in the process shown in FIG. 4 of recording telephone conversation contents between the respective advisers and the customers as described above, the telephone conversation contents recording server 150 is configured to record all telephone conversation contents provided from the respective adviser PCs 140-1, 140-2, . . . , 140-m, in a different manner from that in the first embodiment of FIG. 3. That is, because the respective adviser PCs selectively transfer telephone conversation contents on the basis of types of advice contents desired by the customers through the above-stated respective steps, the conversation contents recording server 150 records all conversation contents provided from the respective adviser PCs, without selecting them.

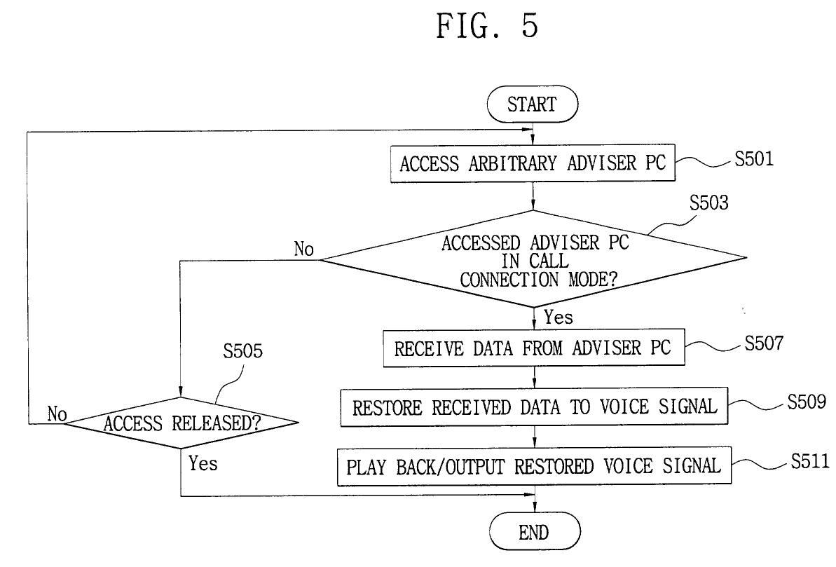

FIG. 5 is a flow chart illustrating a telephone conversation monitoring process in the telephone conversation recording process of the multi-channel digital recording system in accordance with the present invention, in which the manager PC 160 or remote manager PC 170 monitors telephone conversation contents of the respective channels. This telephone conversation monitoring process can be equally applied to the respective embodiments of FIGS. 3 and 4.

With reference to FIG. 5, first, the manager PC 160 accesses an arbitrary adviser PC to be monitored, through a predetermined log-in process (step S501), and then determines whether a corresponding adviser is in a call connection mode by determining whether data from the accessed adviser PC is outputted (step S503). Upon determining that the corresponding adviser is not in the call connection mode, the manager PC 160 after canceling the connection with the corresponding adviser and, it accesses a different arbitrary adviser PC (step S505). However, if the corresponding adviser is in the call connection mode, the manager PC 160 receives output data from the adviser PC (step S507), restores the received data to the original voice signal through predetermined decompression and decoding processes (step S509), and then outputs the restored voice signal through a speaker, etc. (step S511), so the manager can monitor telephone conversation contents of the corresponding channel on a real time basis.

This monitoring process can also be performed in the remote manager PC 170 connected via the WAN, in the same manner.

Consequently, in the telephone conversation recording process of the multi-channel digital recording system in accordance with the present invention, telephone conversation contents provided from a plurality of traffic channels can be selectively recorded according to a recording schedule made out by a manager or types of advice contents selected by customers. Further, the manager can monitor an arbitrary channel on a real time basis.

Furthermore, the present invention can accommodate a VOIP (Voice Over Internet Protocol)-based call connection over the Internet as well as a call connection over the PSTN.

As apparent from the above description, according to the present invention, a recording operation and playback operation can be performed through a PC connected via a LAN or the Internet, resulting in no need for a separate analog line construction and no restriction in the number of managers. Further, a database construction function, a simultaneous recording function and an instant playback function can be performed with respect to telephone conversation contents, and a monitoring function can be performed to select a current call-connected channel and play back telephone conversation contents of the selected channel. Particularly, various searches, such as searches by advisers, searches by conversation categories, searches by conversation lengths and searches by advice types, can be conducted on the basis of a constructed database. Furthermore, telephone conversation contents provided from a plurality of traffic channels can be selectively recorded according to a predetermined recording schedule or types of advice contents selected by customers.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for recording telephone conversation contents between a plurality of advisers and a plurality of customers in a multi-channel digital recording system using a network, said system including a plurality of adviser telephones, a plurality of adviser personal computers (PCs) connected respectively with said adviser telephones, a telephone conversation contents recording server connected with said adviser PCs over said network, and a PABX (Private Automatic Branch exchange) for relaying calls between said adviser telephones and a telephone network, said method comprising the steps of:
a) allowing said PABX to connect a call between an arbitrary customer telephone and an arbitrary one of said adviser telephones if said arbitrary customer telephone is connected to said PABX over said telephone network;
b) allowing said arbitrary adviser telephone to transfer contents of a telephone conversation with an arbitrary one of said customers corresponding to said arbitrary customer telephone to an arbitrary one of said adviser PCs corresponding to said arbitrary adviser telephone in the form of an analog voice signal;
c) allowing said arbitrary adviser PC to convert said analog voice signal transferred from said arbitrary adviser telephone into a digital voice signal, convert the converted digital voice signal into computer-readable audio data through a predetermined compression process and transfer the converted audio data to said telephone conversation contents recording server on a real time basis; and
d) allowing said conversation contents recording server to record said audio data transferred from said arbitrary adviser PC.

2. The method as set forth in claim 1, wherein said step a) includes the steps of:
a-1) allowing said PABX to, if said customer telephone is connected to said PABX over said telephone network, send out a guidance message to request said arbitrary customer to enter basic customer information for identification of said arbitrary customer; and
a-2) allowing said PABX to, if said basic customer information from said customer telephone is inputted in the form of a dual tone multi-frequency (DTMF) signal, recognize the inputted DTMF signal, transfer said basic customer information corresponding thereto to said arbitrary adviser PC and connect the call between said customer telephone and said arbitrary adviser telephone.

3. The method as set forth in claim 1, wherein said step c) includes the step of allowing said arbitrary adviser PC to code and transfer said converted audio data.

4. The method as set forth in claim 1, wherein said conversation contents recording server is adapted to prestore a recording schedule, said recording schedule being made out to selectively record audio data transferred respectively from said adviser PCs on a time basis; and
wherein said step d) includes the step of allowing said conversation contents recording server to execute said recording schedule, sequentially select ones of said adviser PCs corresponding to said recording schedule and sequentially record said audio data transferred from the selected adviser PCs.

5. The method as set forth in claim 1, wherein said multi-channel digital recording system further includes a manager PC connected with said plurality of adviser PCs; and
wherein said method further comprises the step of:
e) allowing said manager PC to access an arbitrary one of said plurality of adviser PCs and receive and monitor said audio data transferred from the accessed adviser PC.

6. The method as set forth in claim 2, wherein said step d) includes the step of allowing said conversation contents recording server to receive information regarding a recording time of said audio data, adviser information and said basic customer information from said arbitrary adviser PC and record the received information along with said audio data.

7. The method as set forth in claim 1, wherein said telephone network is a VOIP (Voice Over Internet Protocol)-based Internet telephone network.

8. A method for recording telephone conversation contents between a plurality of advisers and a plurality of customers in a multi-channel digital recording system using a network, said system including a plurality of adviser telephones, a plurality of adviser personal computers (PCs) connected respectively with said adviser telephones, a telephone conversation contents recording server connected with said adviser PCs over said network, and a PABX (Private Automatic Branch eXchange) for relaying calls between said adviser telephones and a telephone network, said method comprising the steps of:
a) prestoring a plurality of selection menus in said PABX in the form of voice guidance messages and setting in each of said adviser PCs a recording condition for selective execution of telephone conversation contents recording according to advice menus;
b) allowing said PABX to send a guidance message to an arbitrary customer telephone to request an arbitrary one of said customers corresponding to said arbitrary customer telephone to select one of said advice menus, if said arbitrary customer telephone is connected to said PABX over said telephone network;
c) allowing said PABX to, if one of said advice menus is selected by said arbitrary customer and a DTMF signal corresponding thereto is inputted from said customer telephone, connect a call between said customer telephone and an arbitrary one of said adviser telephones, identify the inputted DTMF signal and notify an arbitrary one of said adviser PCs corresponding to said arbitrary adviser telephone of the selected advice menu;
d) allowing said arbitrary adviser telephone to transfer contents of a telephone conversation with said arbitrary customer to said arbitrary adviser PC in the form of an analog voice signal;
e) allowing said arbitrary adviser PC to, if said notified advice menu corresponds to said set recording condition, convert said analog voice signal transferred from said arbitrary adviser telephone into a digital voice signal, convert the converted digital voice signal into computer-readable audio data through a predetermined compression process and transfer the converted audio data to said telephone conversation contents recording server on a real time basis; and
f) allowing said conversation contents recording server to record said audio data transferred from said arbitrary adviser PC.

9. The method as set forth in claim 8, wherein said step e) includes the step of allowing said arbitrary adviser PC to code and transfer said converted audio data.

10. The method as set forth in claim 8, wherein said step b) includes the steps of:
b-1) allowing said PABX to send a guidance message to said customer telephone to request said arbitrary customer to enter basic customer information for identification of said arbitrary customer; and
b-2) allowing said PABX to, if said basic customer information from said customer telephone is inputted in the form of a DTMF signal, recognize the inputted DTMF signal and transfer said basic customer information corresponding thereto to said arbitrary adviser PC.

11. The method as set forth in claim 8, wherein said multi-channel digital recording system further includes a manager PC connected with said plurality of adviser PCs; and
wherein said method further comprises the step of:
g) allowing said manager PC to access an arbitrary one of said plurality of adviser PCs and receive and monitor said audio data transferred from the accessed adviser PC.

12. The method as set forth in claim 10, wherein said step f) includes the step of allowing said conversation contents recording server- to receive information regarding a recording time of said audio data, adviser information and said basic customer information from said arbitrary adviser PC and record the received information along with said audio data.

13. The method as set forth in claim 11, wherein said manager PC is a remote manager PC, said remote manager PC remotely accessing said adviser PCs and said conversation contents recording server over a wide area network, said wide area network being the Internet.

14. The method as set forth in claim 8, wherein said telephone network is a VOIP-based Internet telephone network.

15. A multi-channel digital recording system for recording telephone conversation contents over a plurality of traffic channels using network environments, comprising:
a PABX for controlling call connections for a plurality of customer telephones connected thereto over a telephone network;
a plurality of adviser telephones connected with said customer telephones via said PABX, said adviser telephones outputting contents of telephone conversations with said customer telephones in the form of analog voice signals;
a plurality of interface modules connected respectively with said adviser telephones, said interface modules interfacing said analog voice signals from said adviser telephones, respectively;
a plurality of adviser PCs connected respectively with said interface modules, said adviser PCs converting said analog voice signals provided from said interface modules into digital voice signals and compressing the converted digital voice signals into computer-readable audio data, respectively; and
a telephone conversation contents recording server connected with said adviser PCs via a local area network (LAN), said recording server recording said audio data from said adviser PCs.

16. The multi-channel digital recording system as set forth in claim 15, further comprising a manager PC connected to said LAN, said manager PC receiving and monitoring said audio data from said adviser PCs.

17. The multi-channel digital recording system as set forth in claim 15, further comprising a remote manager PC connected to said LAN over the Internet, said remote manager PC receiving and monitoring said audio data from said adviser PCs.

18. The multi-channel digital recording system as set forth in claim 15, wherein said conversation contents recording server is adapted to selectively record said audio data from said adviser PCs on a time basis according to a preset recording schedule.

19. The multi-channel digital recording system as set forth in claim 15, wherein said adviser PCs are each adapted to code said audio data and transfer the coded audio data to said conversation contents recording server.

20. The multi-channel digital recording system as set forth in claim 15, further comprising a customer information database (DB) server connected to said LAN, said customer information database (DB) server storing detailed information regarding all customers in the form of a database;
wherein said PABX is adapted to induce an arbitrary one of said customer telephones connected thereto over said telephone network to enter a unique number for customer identification, through an audio response system (ARS) function; and
wherein said customer information DB server is adapted to search for the detailed information regarding one of the customers corresponding to the entered unique number and transfer the searched information to one of said adviser PCs, call-connected with said arbitrary customer telephone, such that the searched information is displayed in the call-connected adviser PC.

21. The multi-channel digital recording system as set forth in claim 15, wherein said PABX includes a gateway server; and
wherein said telephone network is a VOIP-based telephone network.
